(19) United States
(12) Patent Application Publication
(10) Pub. No.: US 2004/0200089 A1
(43) Pub. Date: Oct. 14, 2004

(54) Body dryer

(76) Inventor: Gerardo Melendrez, Los Angeles, CA (US)

Correspondence Address: Kenneth L. Tolar, 808 N. Causeway Blvd., Metairie, LA, 70001, US

(21) Appl. No.: 10/808,112

(22) Filed: Mar. 24, 2004

Related U.S. Application Data
(63) Continuation-in-part of application No. 10/409,824, filed on Apr. 9, 2003, now abandoned.

(51) Int. Cl. F26B 19/00

(52) U.S. Cl. 34/90

(57) ABSTRACT

A body dryer includes a housing having a convex front wall, a pair of side walls, a top wall, a bottom wall and a rear wall. The housing is pivotally mounted on a support stand. A hot air blower assembly is received within the housing interior for projecting a stream of hot air through a plurality of vents positioned on the convex front wall. The heat intensity is selectively varied with a switch positioned on the top wall of the housing.

### CROSS REFERENCED TO RELATED APPLICATIONS

This application is a continuation-in-part of application Ser. No. 10/409,824 filed on Apr. 9, 2003.

### BACKGROUND OF THE INVENTION

1. Technical Field of the Invention

The present invention relates to a body dryer for complementing a hand towel to more easily and efficiently dry a bather's body.

2. Description of the Prior Art

Bathers and swimmers typically dry with a towel. However, because not all areas of the body are readily accessible with a towel, the bather is rarely able to completely dry off. Accordingly, the bather may still be wet when dressing which is unpleasant. Furthermore, exiting a shower or bathtub during the winter months is always extremely uncomfortable.

Finally, overweight people and those with certain physical disabilities cannot reach certain areas of the body such as the feet or toes. Accordingly, drying such areas with a towel is not possible. The present invention addresses these problems by providing a uniquely designed body dryer that directs heated air toward a user. By using the device in conjunction with a towel, a bather can quickly and completely dry all areas of the bather's body. The device also directs hot air to otherwise inaccessible areas of the body such as between the toes. Furthermore, the device heats ambient air thereby removing moisture from bathroom surfaces such as mirrors, floors and counter tops; the device also immediately directs hot air toward a bather so as to eliminate the initial discomfort associated with exiting a shower or bathtub.

### SUMMARY OF THE INVENTION

The present invention relates to a body dryer. The device is designed primarily to rest on the floor or a similar supporting surface and includes a housing having a plurality of adjustable vents on the front surface thereof. A fan and plurality of heaters are positioned within the housing interior. When the device is activated, heated air is projected through the vents to the atmosphere. The housing is pivotally mounted on a support stand allowing the angular orientation of the housing to be selectively varied, if desired.

It is therefore an object of the present invention to provide a body dryer that significantly enhances the use of a hand towel.

It is another object of the present invention to provide a body dryer having a selectively variable heating means.

It is yet another object of the present invention to provide a body dryer that is capable of selectively directing multiple streams of heated air to the atmosphere.

Other objects, features and advantages of the present invention will become readily apparent from the following detailed description of the preferred embodiment when considered with the attached drawings and the appended claims.

### BRIEF DESCRIPTION OF THE DRAWINGS

FIG. 1 is a perspective view of the body dryer according to the present invention.

FIG. 2 is a rear view of the body dryer according to the present invention.

FIG. 3 is a side view of the hot air blower assembly.

FIG. 4 is a side view of a louver assembly associated with the air vents of the present invention.

FIG. 5 is a front view of the louver assembly depicted in FIG. 3.

FIG. 6 is a circuit diagram of the various electronics associated with the hot air blower assembly.

### DESCRIPTION OF THE PREFERRED EMBODIMENT

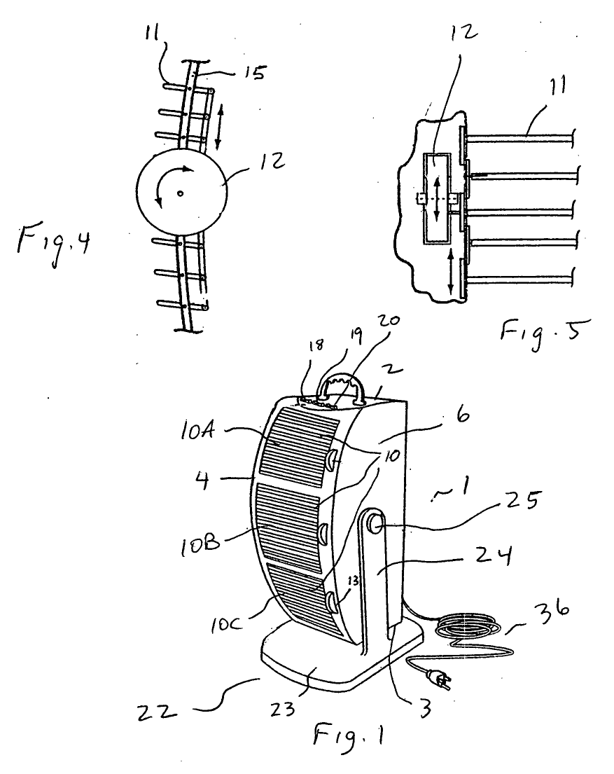

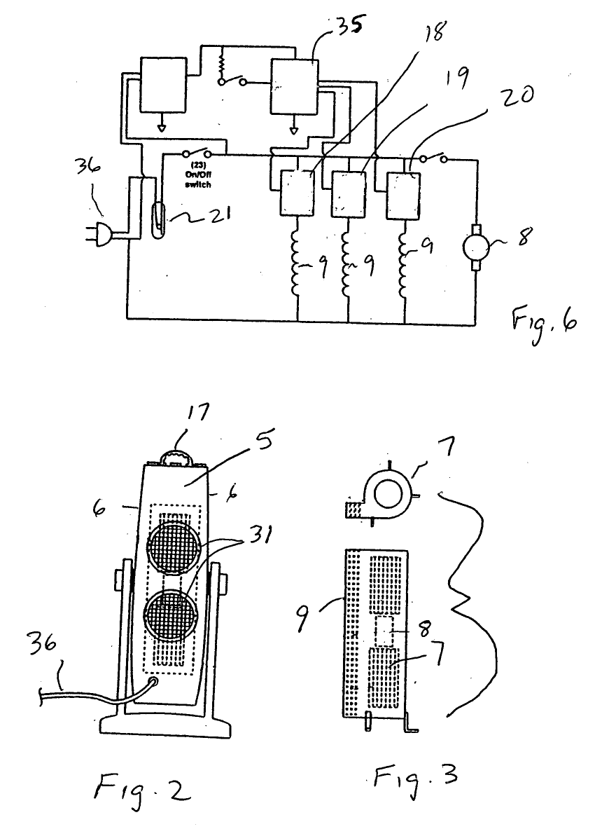

Referring now to FIGS. 1 through 6, the present invention relates to a body dryer. The device comprises a substantially hollow housing 1 having a top end 2, a bottom end 3, a front wall 4, a rear wall 5 and two side walls 6. The housing also includes an interior compartment having a hot air blower assembly received therein.

The hot air blower assembly includes a squirrel cage type fan 7 that is operated by an AC motor 8. The fan includes an air outlet with a plurality of heaters 9 adjacent thereto. In the preferred embodiment, there are three heaters though the number can be varied. An electrical cord 36 for coupling with a conventional AC electrical receptacle provides power to the motor and heaters.

The front wall of the housing is convex and includes of plurality of air vents 10 positioned thereon. Preferably, there are three vents: one 10A for projecting heated air upwardly, another 10B for projecting air straight ahead and the third 10C for projecting air downwardly. However, the number of vents can be varied.

Each vent includes a plurality of pivotal louvers 11 positioned therein. The direction of the louvers may be selectively adjusted with a rotatable dial 12 that protrudes through a slot 13 on the front wall of the housing, immediately adjacent the vent. As depicted in FIGS. 4 and 5, each louver includes a pair of opposing side edges each of which are pivotally connected to the housing. Each louver further includes a rear edge pivotally connected to a link 15. Each vent adjustment dial is fixedly attached to the link whereby rotation of the dial results in simultaneous upward or downward pivoting of the louvers. Air intake vents 31 are positioned on the rear wall of the housing for supplying fresh ambient air to the hot air blower assembly.

On the top wall of the housing is a handle 17 which may be grasped when the user is relocating the body dryer. Immediately adjacent the handle are a plurality of switches 18, 19, 20 that control the operation of the hot air blower assembly. A first switch 18 activates the assembly. A second switch 19 controls the heat intensity generated by the hot air blower assembly when activated. For example, depressing the switch a first time will activate one of the internal heaters. Depressing the switch a second time will also activate a second heater while depressing it a third time will result in all three heaters being activated. Depressing the switch a fourth time disables all heaters for directing ambient air to a user if desired, such as when the device is being used in warmer climates. The third switch 20 enables and disables the blower assembly. As depicted in FIG. 6, a microprocessor 35 is electrically connected to the heater control switch for controlling the operation of the heaters as described above. Also, the device includes an internally disposed gravity switch 21 for disabling electrical power to the heaters and blower in the event that the housing is inadvertently overturned.

The housing is uprightly supported by a weighted stand 22 allowing it to be placed on a flat surface such as the floor or counter top. The stand includes a horizontal planar base portion 23 with a pair of mounting arms 24 vertically extending therefrom. A distal end of each arm is fastened to a respective side wall of the housing with an adjustment knob 25. The adjustment knob may be loosened slightly allowing the angular position of the housing to be varied relative to the stand to selectively redirect hot air flow. The knob is then re-tightened to secure the housing in the selected orientation.

As is now readily apparent, the present invention provides a uniquely designed device that more effectively dries a bather. The convex, arcuate front wall allows the device to panoramically project heated air to quickly and efficiently dry the bather. Furthermore, the pivotal housing in conjunction with the adjustable louvers allow a user to direct multiple streams of hot air in virtually any desired direction.

The above described device in not limited to the exact details of construction and enumeration of parts provides herein. Furthermore, the size, shape and materials of construction of the various components may be varied.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A body dryer comprising:
a housing having a front wall, a rear wall and a pair of side walls;
a plurality of vents positioned on the front wall of said housing;
a hot air blower assembly received within said housing for dispersing hot air through said vents;
means for varying the temperature of hot air generated by said hot air blower assembly.

2. The body dryer according to claim 1 wherein said hot air blower assembly comprises a fan having an air output with a plurality of heaters positioned adjacent thereto.

3. The body dryer according to claim 2 wherein said means for adjusting the temperature of hot air comprises:
a switch means positioned on the top wall of said housing;
a microprocessor means in communication with said switch means for sequentially activating a select one of said heaters each time said switch means is actuated.

4. The body dryer according to claim 1 further comprising a gravity actuated safety switch electrically connected to said hot air blower assembly for disabling power thereto in the event said housing is overturned.

5. The body dryer according to claim 1 wherein said housing front wall is convex so that said vents simultaneously project hot air upwardly, downwardly, and straight ahead.

6. The body dryer according to claim 1 wherein each of said vents includes a plurality of pivotal louvers operably connected to an adjustment dial, said adjustment dial positioned on the front wall of said housing whereby said dial is rotated to pivot said louvers so as to redirect hot air.

7. The body dryer according to claim 1 wherein said housing is pivotally mounted on a weighted support stand that uprightly supports said housing.

8. The body dryer according to claim 7 wherein said support stand includes a planar base portion with a pair of spaced arms extending upwardly therefrom, each of said arms terminating at a distal end;
an adjustment knob releasably securing the distal end of each of said arms to one of said housing sidewalls allowing said housing to be angularly adjusted.
